(19) United States
(12) Patent Application Publication
(10) Pub. No.: US 2026/0307606 A1
(43) Pub. Date: Oct. 8, 2026

(54) METHOD FOR CONTROLLING VEHICLE POWER OPERATION

(71) Applicants: Hyundai Motor Company, Seoul (KR); Kia Corporation, Seoul (KR)

(72) Inventors: Seon-Min KIM, Hwaseong-si (KR); Chong-Bae PARK, Hwaseong-Si (KR); Jea-Won HAN, Hwaseong-Si (KR); Jong-Hoon AHN, Hwaseong-si (KR); Hyung-Gyu RA, Hwaseong-Si (KR); Hyun-Sung HWANG, Hwaseong-Si (KR); Hong-Min OH, Hwaseong-Si (KR); Kyu-Ri KIM, Hwaseong-Si (KR)

(21) Appl. No.: 19/387,295

(22) Filed: Nov. 12, 2025

(30) Foreign Application Priority Data
Apr. 4, 2025 (KR) 10-2025-0044000

(51) Int. Cl. B60R 16/023; G06F 3/14; G07C 5/02; G07C 5/08

(52) U.S. Cl. CPC B60R 16/0231; G06F 3/14; G07C 5/02; G07C 5/0825

(57) ABSTRACT

In a method for transitioning a display screen and/or vehicle power to maximize utilization of a full-screen mode, in response to vehicle power-on, a power controller changes the vehicle power from a power-off state to a power-on state. A. A display controller outputs a user mode on a display unit for displaying content before a vehicle enters a drive-ready mode.

### CROSS-REFERENCE TO RELATED APPLICATION

The present application claims priority to Korean Patent Application No. 10-2025-0044000, filed on Apr. 4, 2025, the entire contents of which is incorporated herein for all purposes by the present reference

### BACKGROUND OF THE PRESENT DISCLOSURE

### Field of the Present Disclosure

The present disclosure relates to a technology for controlling vehicle power operation.

### Description of Related Art

There is a growing trend toward the expanded application of a user interface (UI) that utilizes the entire area of a display screen to provide functions such as video viewing.

When vehicle power is turned on, it is necessary to operate a mandatory display function that is required to be provided by laws and regulations.

Accordingly, when such a mandatory display function is also activated, displaying content such as a video by utilizing the full screen of the display is restricted.

To elaborate, it becomes necessary either to limit the display to a condition where the power is turned off, or to display content by utilizing only a portion of the full screen. In the instant case, the usability of displaying content such as a video by utilizing the full screen is constrained.

### BRIEF SUMMARY

Various aspects of the present disclosure provide a method for transitioning a display screen and vehicle power to maximize utilization of a full-screen mode.

Various aspects of the present disclosure provide a method for transitioning a display screen and/or vehicle power to maximize utilization of a full-screen mode in compliance with applicable laws and regulations.

The method may include: in response to vehicle power-on, changing, by a power controller, vehicle power from a power-off state to a power-on state; and outputting, by a display controller, a user mode on a display unit for displaying content before a vehicle enters a drive-ready mode.

Furthermore, the user mode may include a first screen mode configured to display mandatory content (i.e., first content) that is preset to be provided as required by laws and regulations among the content, and a second screen mode configured not to display the mandatory content but to display remaining content (i.e., second content).

Furthermore, the second screen mode may use a full screen to display the remaining content.

Furthermore, the outputting on the display unit may include: entering, by the power controller, the first screen mode, based on determining that first designated input, preset in an ignition-on (IG-ON) mode of the power-on state, is present; in the entering the first screen mode state, entering, by the power controller, the second screen mode or the drive-ready mode, based on determining that the first designated input is present again; and after the entering the second screen mode, entering, by the power controller, a standby mode before entering the drive-ready mode, based on determining that preset third designated input is present.

Furthermore, the entering the drive-ready mode may include: after determining whether the first designated input is present again, maintaining the first screen mode or entering the drive-ready mode, based on determining that preset second designated input is present for a first set time period.

Furthermore, the entering of the standby mode may include: returning, by the power controller, from the standby mode to the first screen mode, based on determining that valid input is not present for a second set time period; and after the determining of that the valid input is present for the second set time period, entering, by the power controller, the drive-ready mode, based on determining that preset fourth designated input is present.

Furthermore, the standby mode may be a waiting mode for entering the drive-ready mode and may be a mode that prevents direct entry from the second screen mode to the drive-ready mode.

Furthermore, the standby mode may be a mode that performs a bulb check function (pre-warning) of a warning light, wherein the bulb check displays, on the display unit, whether abnormality of the vehicle is present.

Furthermore, the standby mode may be a mode that displays the mandatory content on the display unit.

Furthermore, the mandatory content may be at least one of vehicle speed, gear shifting position display, or various warning lights.

Furthermore, the display unit may be a display in which a cluster and Audio, Video, and Navigation (AVN) are integrated.

According to various aspects of the present disclosure, a vehicle user may experience infotainment functionality utilizing the vehicle's display in a wider variety of usage scenarios (environments).

### BRIEF DESCRIPTION OF THE DRAWINGS

FIG. 1 is a block diagram of a configuration of a vehicle power operation control device according to an exemplary embodiment of the present disclosure.

FIG. 2 is a conceptual diagram of vehicle power mode transition control according to an exemplary embodiment of the present disclosure.

FIG. 3 is a flowchart showing a process of controlling vehicle power operation according to the conceptual diagram illustrated in FIG. 2.

FIG. 4 is a flowchart showing a process of entering a standby mode for a second screen mode, following the flowchart in FIG. 3.

FIG. 5 is a flowchart showing a process of entering another mode through the standby mode, following the flowchart in FIG. 4.

FIG. 6 is an example screen that displays designated input for mode transition according to an exemplary embodiment of the present disclosure.

FIG. 7 is an example screen that displays designated input for mode transition according to another exemplary embodiment of the present disclosure.

FIG. 8 is an example screen that displays designated input for mode transition according to yet another exemplary embodiment of the present disclosure.

### DETAILED DESCRIPTION

An exemplary embodiment of the present disclosure will be described in detail below with reference to the accompanying drawings. The same reference numerals are used to indicate the same or similar components in the drawings.

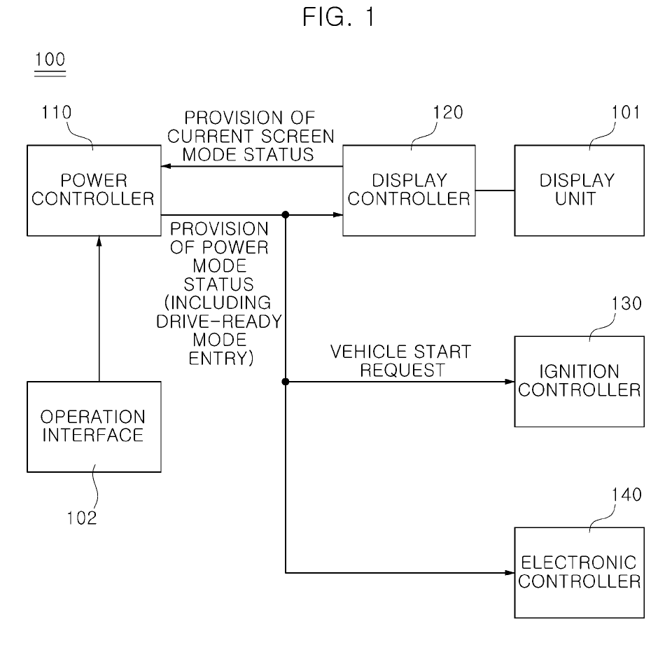

FIG. 1 is a block diagram of a configuration of a vehicle power operation control device 100 according to an exemplary embodiment of the present disclosure. Referring to FIG. 1, the vehicle power operation control device 100 may include a display unit 101, an operation interface 102, a power controller 110, a display controller 120, an ignition controller 130, an electronic controller 140, and the like.

The display unit 101 may be a display in which a cluster and Audio, Video, and Navigation (AVN) are integrated. Of course, the cluster, AVN, or the like may also be configured separately. The display may be a liquid crystal display (LCD), a light emitting diode (LED) display, an organic LED (OLED) display, a touch screen, a flexible display, a micro LED, a mini LED, a head-up display (HUD), or the like.

For the display in which a cluster and AVN are integrated, there are limitations on how to utilize the full screen of the display with a mandatory display function activated as well.

Furthermore, the display unit 101 may be used as an output means as well as an input means. In general, touch sensor technology may be applied to a display to process user input. To elaborate, user input may be generated by touching an icon output on the screen.

Furthermore, the display unit 101 may include a sound system such as a microphone and a speaker. Accordingly, it is also possible to process user input through voice.

The operation interface 102 may be a brake pedal, an accelerator, a shift lever, an ignition button, a shift button, or the like that provides user input based on an action of a user (i.e., a driver). For example, the input may be a double input of the brake pedal.

The power controller 110 performs controlling vehicle’s power mode. To elaborate, the power controller 110 is configured to control state transition related to a current power operation mode of the vehicle. Furthermore, the power controller 110 performs transmitting current power mode status information to each of the electronic controllers 140 of the vehicle.

The display controller 120 performs controlling the display unit 101. Furthermore, the display controller 120 performs transmitting user input information, which is generated by user input on the display unit 101, to the power controller 110. Furthermore, the display controller 120 performs providing current screen mode status information for controlling the operation of the power controller 110.

The ignition controller 130 performs controlling an ignition device to start the vehicle in response to a vehicle start request from the power controller 110. In general, the ignition device includes a motor, a switching element, a battery, or the like.

The electronic controller 140 performs controlling an electronic component of the vehicle. Examples of electronic components may include an airbag control unit (ACU), heating, ventilation, and air conditioning (HVAC), a lighting device, a reducer, an inverter, or the like.

The power controller 110, the display controller 120, the ignition controller 130, and the electronic controller 140 illustrated in FIG. 1 may include a microcontroller, a microprocessor, memory, a communication circuit, a program, or the like.

In an exemplary embodiment of the present disclosure, the power controller 110, the display controller 120, the ignition controller 130, and the electronic controller 140 may embody one or more processor(s).

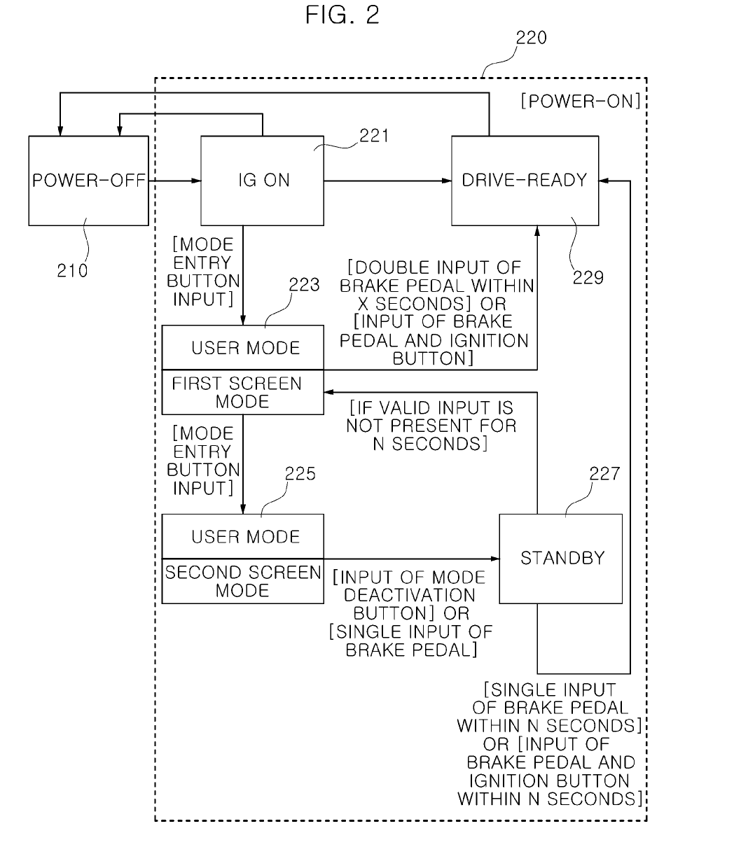

FIG. 2 is a conceptual diagram of vehicle power mode transition control according to an exemplary embodiment of the present disclosure. Referring to FIG. 2, vehicle power mode may be broadly divided into a power-off state 210 and a power-on state 220. The power-off state 210 indicates that the vehicle's power is in the OFF state

When the vehicle's power is turned on, the power controller 110 changes the vehicle's power from the power-off state 210 to the power-on state 220. To elaborate, in the power-off state 210, when the vehicle's power is turned on by user operation (e.g., selection by pressing an ignition button, remote control, etc.), a change into an ignition-on (IG-ON) mode 221 of the power-on state 220 occurs.

The IG-ON mode 221 is a normal mode and is a state prior to entering a drive-ready mode 229. Accordingly, in the IG-ON mode 221, functions unrelated to driving are activated.

Transition from the IG-ON mode 221 to user modes 223 and 225 occurs in response to user input (e.g., mode entry button input). The user modes 223 and 225 are power-on states, but not driving states (i.e., the ignition is off), and provide a mode that enables the use of convenience features by utilizing the vehicle's battery.

The mode entry button is an example, and mode entry may also include use of the press duration and/or the number of presses of the ignition button disposed in the vehicle, through voice input or the like. Furthermore, the mode entry button may also be configured separately within the vehicle.

The user modes 223 and 225 are output on the display unit 101, and based on the operation mode, operate in two divided modes. That is, the user modes 223 and 225 include a first screen mode 223 and a second screen mode 225. The first screen mode 223 is a normal screen mode, and the second screen mode 225 is a full-screen mode.

The first screen mode 223 displays mandatory content (i.e., first content) that is preset to be provided as required by laws and regulations. Examples of mandatory content may include vehicle speed, gear shifting position display, and various warning lights. The second screen mode 225 utilizes the full screen to display the remaining content other than the mandatory content.

If user input is present again in the first screen mode 223, transition to the second screen mode 225 occurs. Of course, if another user input is present in the first screen mode 223 (e.g., a double input of the brake pedal within X seconds or an input of the brake pedal and the ignition button), entry to the drive-ready mode 229 occurs.

If user input is present in the second screen mode 225 (e.g., an input of a mode deactivation button or a single input of the brake pedal), entry to a standby mode 227 occurs. The standby mode 227, which is a waiting mode for entering the drive-ready mode 229, is configured to prevent entry to the drive-ready mode 229 from the second screen mode 225 at once, and performs functions to meet legal requirements.

The mode deactivation button is an example, and mode deactivation may also be made by use of the press duration and/or the number of presses of the ignition button disposed in the vehicle, through voice input or the like. Furthermore, the mode deactivation button may also be configured separately within the vehicle.

The standby mode 227 performs a bulb check function (pre-warning) of various warning lights required by laws and regulations (e.g., a warning light image on an instrument panel) and normally displays all other mandatory content required to be displayed by laws and regulations. Here, the bulb check function (pre-warning) of various warning lights may mean displaying information on the display unit 101 to check whether abnormality of the vehicle is present and identify where the abnormality occurs.

If user input is present in the standby mode 227 (e.g., a single input of the brake pedal within N seconds or an input of the brake pedal and the ignition button within N seconds), entry to the drive-ready mode 229 occurs. N seconds may be approximately 30 to 59 seconds, for example.

Furthermore, if valid input is not present for N seconds in the standby mode 227, return to the first screen mode 223 occurs.

As illustrated in the conceptual diagram in FIG. 2, content may be displayed using the full screen even under the vehicle's power-on condition. Furthermore, freedom in the design of the on-screen human machine interface (HMI) on the display unit 101 may be enhanced.

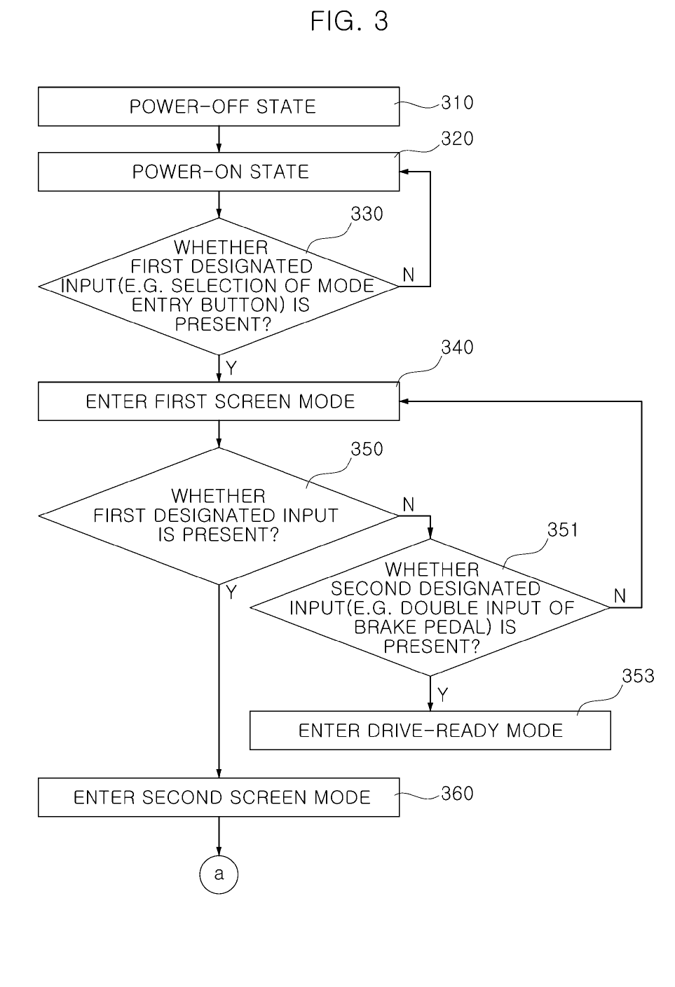

FIG. 3 is a flowchart showing a process of controlling vehicle power operation according to the conceptual diagram illustrated in FIG. 2. Referring to FIG. 3, as the vehicle power is turned on, the power controller 110 changes the vehicle power from a power-off state to a power-on state (310). That is, a transition from a power-off state to the IG-ON mode state occurs (320).

The power controller 110 then determines whether first designated input is present (330). Examples of the first designated input may include a selection of the mode entry button. The mode entry button may be configured in the operation interface 102. Of course, the designated input may be based on other forms of user input, such as voice and screen touch.

In step 330, based on determining that the first designated input is not present, steps 320 and 330 are repeated.

In contrast, based on determining that the first designated input is present in step 330, the power controller 110 enters a first screen mode (i.e., normal screen mode) (340). Accordingly, the power controller 110 transmits current screen mode status information to the display controller 120, and the display controller 120 outputs the first screen mode on the display unit 101. In the instant case, the first screen mode normally displays mandatory content that is required to be provided by laws and regulations.

The power controller 110 then determines whether first designated input is present again (350).

Based on determining that the first designated input is present again in step 350, the power controller 110 enters a second screen mode (i.e., a full-screen mode) (360). To elaborate, if the first designated input is entered again in the first screen mode, entry to the second screen mode may occur.

The second screen mode is a mode that maximizes infotainment functionality, and may use the full screen of the display to display remaining content (i.e., second content) other than the mandatory content. Furthermore, the second screen mode may minimize or suppress the vehicle status display function.

In contrast, based on determining that the first designated input is not present again in step 350, the power controller 110 is configured to determine whether second designated input is present for a predetermined time period (i.e., a first set time period (X seconds)) (351). Examples of the second designated input may include a double input of the brake pedal within X seconds or a simultaneous input of the brake pedal and the ignition button. Of course, the designated input may be based on other forms of user input, such as voice and screen touch. Furthermore, X seconds may be approximately 60 to 120 seconds, for example.

In step 351, based on determining that the second designated input is not present, steps 340 to 351 are repeated.

In contrast, based on determining that the second designated input is present in step 351, the power controller 110 enters the drive-ready mode (353). To elaborate, certain operation of the operation interface 102 (e.g., a double input of the brake pedal) enables entry into the drive-ready mode, which is the ignition mode, at once.

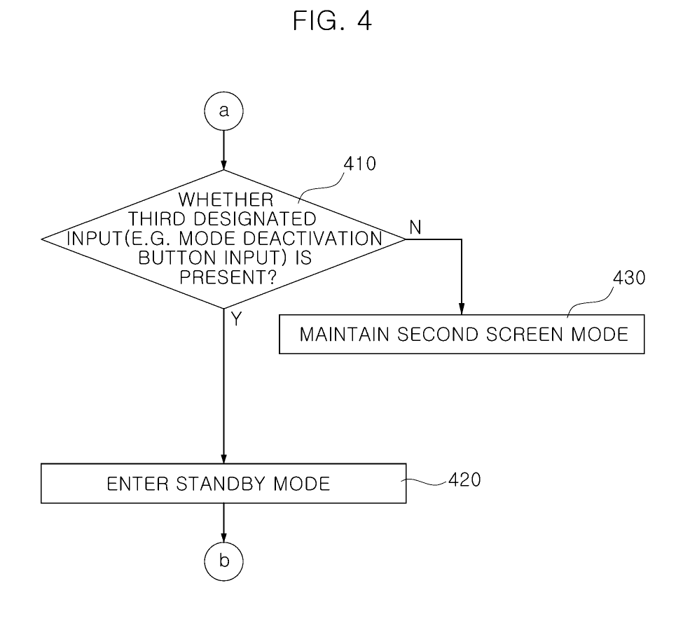

FIG. 4 is a flowchart showing a process of entering a standby mode for a second screen mode, following the flowchart in FIG. 3. Referring to FIG. 4, after entering the second screen mode, the power controller 110 is configured to determine whether third designated input is present (410). Examples of the third designated input may include mode deactivation button input. Of course, the designated input may be based on other forms of user input, such as voice and screen touch.

Based on determining that the third designated input is present in step 410, the power controller 110 enters the standby mode (420). By configuring the standby mode, which is a waiting mode, entry into the drive-ready mode, which is the ignition-on mode, at once is not possible; and if the condition for attempting entry into the drive-ready mode is satisfied, the power controller 110 may enter the standby mode 227, which is a stage prior to entering the drive-ready mode 229.

The standby mode 227, which is a waiting mode for entering the drive-ready mode 229, performs preventing entry to the drive-ready mode 229 from the second screen mode 225 at once. That is, the standby mode 227 prevents direct entry from the second screen mode 225 to the drive-ready mode 229. Furthermore, the standby mode 227 is a mode that performs functions required to meet legal requirements.

In contrast, based on determining that the third designated input is not present in step 410, the power controller 110 maintains the second screen mode (430).

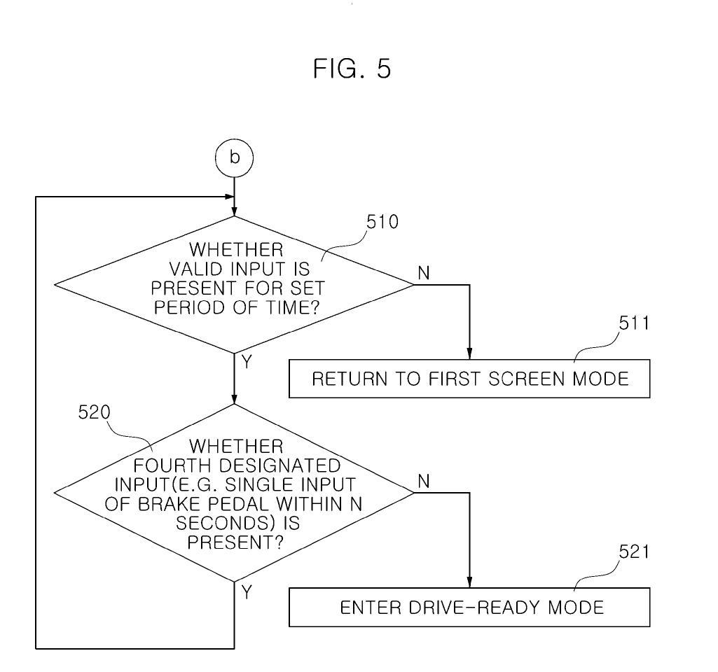

FIG. 5 is a flowchart showing a process of entering another mode through the standby mode, following the flowchart in FIG. 4. Referring to FIG. 5, the power controller 110 is configured to determine whether valid input is present for a set time period (e.g., N seconds) (510).

Based on determining that valid input is not present for a set time period in step 510, the power controller 110 returns from the standby mode to the first screen mode (511). After entry into the standby mode, if no additional ignition entry input occurs within a set time period, the power controller 110 returns from the standby mode to the first screen mode. Examples of ignition entry input may include a single input of the brake pedal within N seconds or a simultaneous input of the brake pedal and the ignition button within N seconds.

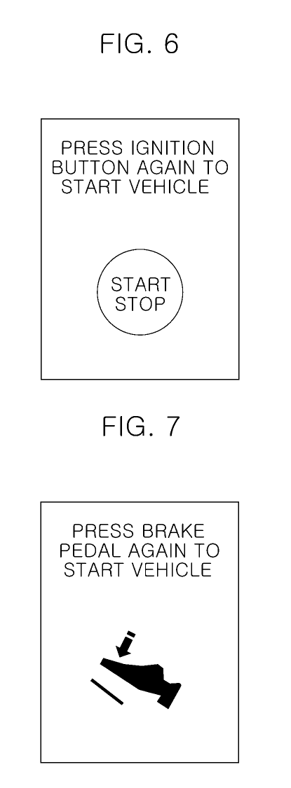

FIG. 6 is an example screen that displays designated input for mode transition according to an exemplary embodiment of the present disclosure. Referring to FIG. 6, selection of the ignition button on the screen is illustrated as an example of designated input. The ignition button may also be generated as an icon on the screen. Accordingly, the mode may be transitioned through soft key input.

FIG. 7 is an example screen that displays designated input for mode transition according to another exemplary embodiment of the present disclosure. Referring to FIG. 7, an example of on-screen information providing instructions to press the brake pedal is illustrated. Accordingly, the user may perform mode transition by pressing the brake pedal.

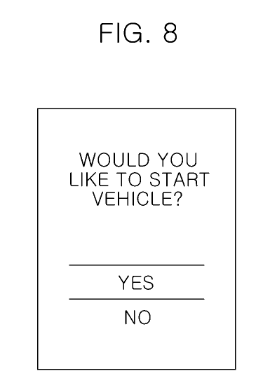

FIG. 8 is an example screen that displays designated input for mode transition according to yet another exemplary embodiment of the present disclosure. Referring to FIG. 8, in the drive-ready mode, which is a temporary mode, a more proactive confirmation of the user's intent to perform ignition entry may be obtained through an intent-querying interaction.

Furthermore, the steps of the methods or algorithms described in connection with the exemplary embodiments included herein may be implemented in a form of program instructions that may be executed by various computing means, such as a microprocessor, a processor, and a central processing unit (CPU), and recorded on a computer-readable medium. The computer-readable medium may include program (instruction) code, a data file, a data structure, and the like, either alone or in a combination thereof.

What is claimed is:

1. A method for controlling vehicle power operation, the method comprising:
in response to vehicle power-on, changing, by a power controller, vehicle power from a power-off state to a power-on state; and
outputting, by a display controller, a user mode on a display unit for displaying content before a vehicle enters a drive-ready mode.

2. The method of claim 1, wherein the user mode includes a first screen mode configured to display first content that is preset to be provided among the content and a second screen mode configured not to display the first content but to display second content.

3. The method of claim 2, wherein the second screen mode utilizes a full screen to display the second content.

4. The method of claim 2, wherein the outputting on the display unit comprises:
entering, by the power controller, the first screen mode, based on determining that first designated input, preset in an ignition-on (IG-ON) mode of the power-on state, is present;
in the entering the first screen mode state, entering, by the power controller, the second screen mode or the drive-ready mode, based on determining that the first designated input is present again; and
after the entering the second screen mode, entering, by the power controller, a standby mode before entering the drive-ready mode, based on determining that preset third designated input is present.

5. The method of claim 4, wherein the entering the drive-ready mode comprises:
after determining that the first designated input is present again, maintaining the first screen mode or entering the drive-ready mode, based on determining that preset second designated input is present for a first set time period.

6. The method of claim 4, wherein the entering of the standby mode comprises:
returning, by the power controller, from the standby mode to the first screen mode, based on determining that valid input is not present for a second set time period; and
after the determining of that the valid input is present for the second set time period, entering, by the power controller, the drive-ready mode, based on determining that preset fourth designated input is present.

7. The method of claim 4, wherein the standby mode is a waiting mode for entering the drive-ready mode and is a mode that prevents direct entry from the second screen mode to the drive-ready mode.

8. The method of claim 4, wherein the standby mode is a mode that performs a bulb check of a warning light, wherein the bulb check displays, on the display unit, that abnormality of the vehicle is present.

9. The method of claim 4, wherein the standby mode is a mode that displays the first content on the display unit.

10. The method of claim 2, wherein the first content is at least one of a vehicle speed, gear shifting position display, or predetermined warning lights.

11. The method of claim 1, wherein the display unit is a display in which a cluster and Audio, Video, and Navigation (AVN) are integrated.

12. A vehicle comprising:
a display unit; and
a controller including a processor and operatively connected to the display unit,
wherein the controller:
in response to vehicle power-on, changes vehicle power from a power-off state to a power-on state; and
outputs a user mode on the display unit for displaying content before the vehicle enters a drive-ready mode.

13. The vehicle of claim 1, wherein the user mode includes a first screen mode configured to display first content that is preset to be provided among the content and a second screen mode configured not to display the first content but to display second content.

14. The vehicle of claim 13, wherein the second screen mode utilizes a full screen to display the second content.

15. The vehicle of claim 13, wherein in the outputting on the display unit, the controller
enters the first screen mode, based on determining that first designated input, preset in an ignition-on (IG-ON) mode of the power-on state, is present;
in the entering the first screen mode state, enters the second screen mode or the drive-ready mode, based on determining that the first designated input is present again; and
after the entering the second screen mode, enters a standby mode before entering the drive-ready mode, based on determining that preset third designated input is present.

16. The vehicle of claim 15, wherein in the entering the drive-ready mode, the controller:
after determining that the first designated input is present again, maintains the first screen mode or enters the drive-ready mode, based on determining that preset second designated input is present for a first set time period.

17. The vehicle of claim 15, wherein in the entering of the standby mode, the controller:
returns from the standby mode to the first screen mode, based on determining that valid input is not present for a second set time period; and
after the determining of that the valid input is present for the second set time period, enters the drive-ready mode, based on determining that preset fourth designated input is present.

18. The vehicle of claim 15, wherein the standby mode is a waiting mode for entering the drive-ready mode and is a mode that prevents direct entry from the second screen mode to the drive-ready mode.

18. The vehicle of claim 15, wherein the standby mode is a mode that performs a bulb check of a warning light, wherein the bulb check displays, on the display unit, that abnormality of the vehicle is present.

20. The vehicle of claim 15, wherein the standby mode is a mode that displays the first content on the display unit.
